(19) United States
(12) Patent Application Publication
(10) Pub. No.: US 2004/0090109 A1
(43) Pub. Date: May 13, 2004

(54) Wheel balance adjusting structure for vehicle

(76) Inventor: Chang-Seop An, Incheon-city (KR)

Correspondence Address: MORGAN, LEWIS & BOCKIUS, LLP., 3300 HILLVIEW AVENUE, PALO ALTO, CA, 94304, US

(21) Appl. No.: 10/701,968

(22) Filed: Nov. 4, 2003

(30) Foreign Application Priority Data
Nov. 6, 2002 (KR) 2002-68390

(51) Int. Cl. B60B 1/00

(52) U.S. Cl. 301/5.21

(57) ABSTRACT

A wheel balance adjusting structure for a vehicle comprising a balance spring mounted inside a wheel for adjustment of the static balance of the wheel, thereby maintaining a fine appearance of the wheel and a firm coupling state between the wheel and the balance spring, resulting in an easy installation and a balance adjustment of the wheel.

### CROSS-REFERENCE TO RELATED APPLICATIONS

This application claims priority of Korean Application No. 10-2002-0068390, filed on Nov. 6, 2002, the disclosure of which is incorporated fully herein by reference.

### FIELD OF THE INVENTION

The present invention relates to a wheel balance adjusting structure for a vehicle and, more particularly, to a technique for adjusting the static balance of a wheel.

### BACKGROUND OF THE INVENTION

In general, there are two types of wheel balance, a static and a dynamic balance for a safe and stable driving. A static balance is a balance of weight distributed around a circumferential surface of a wheel. A wheel that has a static imbalance causes a bouncing action or wheel tramping, producing uneven wear on a tire.

Therefore, balance weights are conventionally added for a static balance of a wheel by being fixed on the rim flange as clip-on weight. Alternatively, balance weights are attached by using an adhesive agent or an adhesive tape.

However, there is a drawback in the typical attachment method using a clip-on weight in that a planar flange surface should be formed in order to install a balance weight on a rim. There is another drawback in that the appearance of the wheel is deteriorated by an outwardly protruded balance weight. There is still another drawback in that the adhesive method using either an adhesive agent or a tape is complicated in installation and balance weights may be detached from a rim by unstable installation.

### SUMMARY OF THE INVENTION

Embodiments of the present invention provide a wheel balance adjusting structure for a vehicle configured to maintain a fine wheel appearance and a firm assembly state in addition to an easy installation method.

In accordance with one embodiment of the present invention, there is provided a wheel balance adjusting structure for a vehicle, wherein the structure comprises an adjusting groove formed inside a wheel along a circumferential direction of the wheel in a predetermined width and depth, and a balance spring inserted into the adjusting groove and taking a shape of a ring with a partially cut-out section.

### BRIEF DESCRIPTION OF THE DRAWINGS

For fuller understanding of the nature and objects of the present invention, reference should be made to the following detailed description taken in conjunction with the accompanying drawings in which:

FIG. 1 is a wheel balance adjusting structure for a vehicle according to a first embodiment of the present invention;

FIG. 2 is a detailed view of an adjusting groove formed inside the wheel of FIG. 1 according to the first embodiment of the present invention; and

FIG. 3 is a detailed view of a balance spring according to a second embodiment of the present invention.

### DETAILED DESCRIPTION OF THE INVENTION

Hereinafter, preferred embodiments of the present invention will be described in detail with reference to the accompanying drawings.

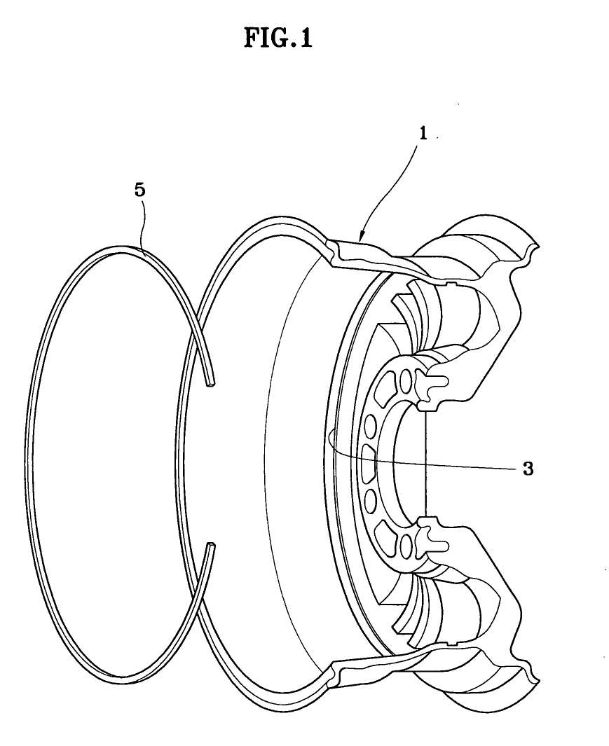

FIG. 1 illustrates a wheel balance adjusting structure for a vehicle according to a first embodiment of the present invention, wherein an adjusting groove 3 is formed inside a whicle 1 into which a balance spring 5 is inserted.

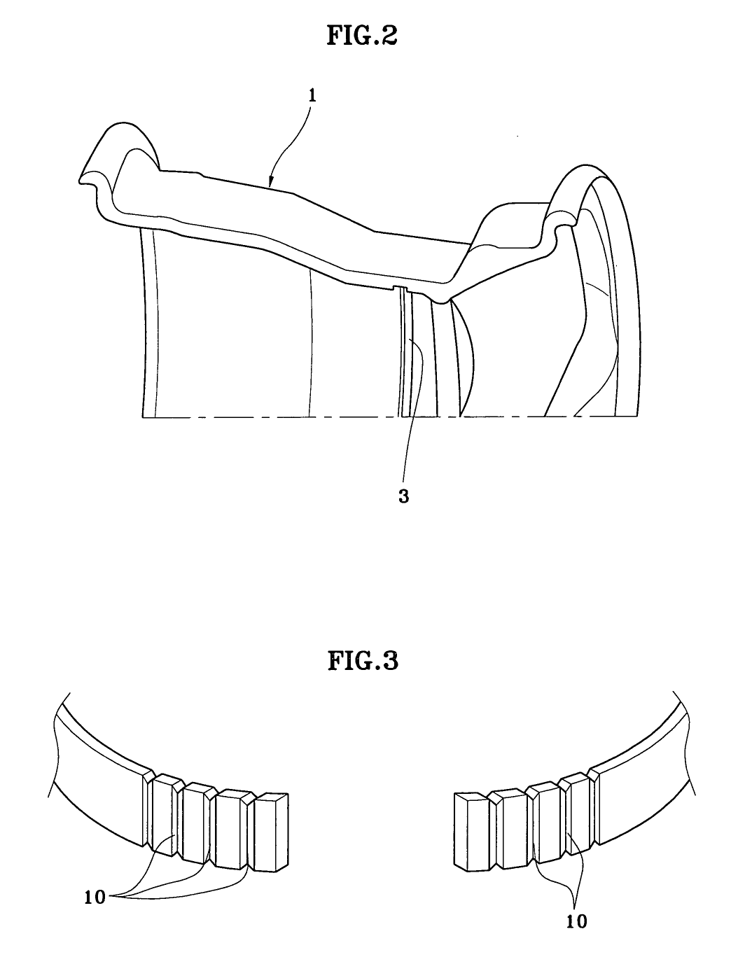

A wheel 1, as shown in FIG. 2, is formed therein with an adjusting groove 3 which has a predetermined width and depth along the circumferential direction of the wheel 1. A ring-shaped balance spring 5 with a partially cut-out section is inserted into the adjusting groove 3. When the balance spring 5 is embedded into the adjusting groove 3, an overall static balance on the wheel 1 is obtained as a result of the partially cut-out section of the balance spring 5. When the balance spring 5 is inserted into the adjusting groove 3 of the wheel 1, the partially cut-out section of the balance spring 5 gets relatively lighter in weight thereof than that of the other sections, providing static balance for the wheel 1.

Thus, in comparison with the conventional method which installs balance weights on the opposite side of the load concentrated part in relation to the center of the wheel, the partially cut-out section of the balance spring 5 according to the present invention is placed on the wheel where weight is concentrated for a relative balance with the other sections.

On the other hand, the balance spring 5 is cut off at the distal ends thereof to attain balance in the wheel 1 and the cut fraction is adjusted depending on the weight preponderance of the wheel 1.

There is an advantage in the wheel balance adjusting structure for a vehicle thus described according to the present invention in that the balance spring 5 is adjusted in weight by cutting a section thereof according to respective wheel states compared with the typical balance weights which typically cannot be changed such that various types of weights are required to adjust the static wheel balance.

With reference to FIG. 3, there is shown a second embodiment of a balance spring according to the invention that provides for easy cutting adjustment. A plurality of cutting notches 10 are provided at preset intervals at both ends of the balance spring for simple and easy cutting of a fraction of the balance spring. An operator can, therefore, adjust the length of the balance spring to be cut off by using the plurality of cutting notches 10 according to respective wheel states.

Of course, the balance spring 5 disposed at an inner side of the adjusting groove 3 of the wheel 1 tends to widen outwardly with resilience along the circumferential direction of the wheel 1. Therefore, once the balance spring 5 is inserted inside the adjusting groove 3, the wheel 1 and balance spring 5 are integrated and are not detached from each other while a vehicle is in motion unless an artificial force is added.

As apparent from the foregoing, there is an advantage in the wheel balance adjusting structure for a vehicle in that a wheel static balance can be adjusted by a balance spring mounted inside a wheel, thereby enabling to maintain a fine exterior look of the wheel and a firm coupling state between the wheel and the balance spring. There is another advantage in that a balance spring can be simply installed to allow easy adjustment of the wheel balance.

What is claimed is:

1. A wheel balance adjusting structure for a vehicle, wherein the structure comprises:
an adjusting groove formed inside a wheel along a circumferential direction of said wheel in a predetermined width and depth; and
a balance spring inserted into said adjusting groove and taking a shape of a ring with a partially cut-out section.

2. The structure as defined in claim 1, wherein a plurality of cutting notches are formed at both ends of said balance spring for simply cutting out a section of said balance spring at a preset interval.
